(19) United States
(12) Patent Application Publication
(10) Pub. No.: US 2026/0048727 A1
(43) Pub. Date: Feb. 19, 2026

(54) ELECTROPNEUMATIC SERVICE BRAKE DEVICE FOR A VEHICLE

(71) Applicant: KNORR-BREMSE SYSTEME FUR NUTZFAHRZEUGE GMBH, Munich (DE)

(72) Inventors: Falk HECKER, Markgroeningen (DE); Juergen STEINBERGER, Groebenzell (DE); Friedbert Roether, Cleebronn (DE); Stefan NIEDERMEIER, Haarbach (DE)

(21) Appl. No.: 19/233,352

(22) Filed: Jun. 10, 2025

Related U.S. Application Data
(63) Continuation of application No. PCT/EP2023/085934, filed on Dec. 14, 2023.

(30) Foreign Application Priority Data
Dec. 21, 2022 (DE) 102022134255.7

(51) Int. Cl. B60T 13/68; B60T 8/17; B60T 8/171; B60T 8/172

(52) U.S. Cl. CPC B60T 13/683; B60T 8/1708; B60T 8/171; B60T 8/172; B60T 2220/04; B60T 2270/10; B60T 2270/20; B60T 2270/304; B60T 2270/402; B60T 2270/404; B60T 2270/413; B60T 2270/82

(57) ABSTRACT

An electropneumatic service brake device (1) for a vehicle, comprising: at least one pneumatic service brake cylinder (BZ1), loadable with a first service brake pressure (p1), and at least one second pneumatic service brake cylinder (BZ2), loadable with a second service brake pressure (p2), a foot brake actuation device (5), a pneumatic foot brake valve device (FBV, FBM), provided and configured to generate a first control pressure (Stp1) and a second control pressure (Stp2) as a function of an actuation of the foot brake actuation device (5), an electronic service brake control (EBS-ECU), provided and configured to generate an electrical control signal as a function of an electrical brake request signal, wherein the electrical control signal represents a nominal service brake pressure, a first electropneumatic solenoid valve device (2C-EVO), provided and configured to be electrically controllable by the electrical control signal, or pneumatically controllable by the first control pressure (Stp1).

### RELATED APPLICATIONS

This application is a continuation of international application PCT/EP 2023/085934, filed on Dec. 14, 2023, claiming priority from German patent application DE 10 2022 134 255.7, filed on Dec. 21, 2022, both of which are incorporated in their entirety by this reference.

### FIELD OF THE INVENTION

The invention relates to an electropneumatic service brake device for a vehicle, in particular, a towing vehicle, configured for trailer operation, and a vehicle configured with the electropneumatic service brake device, in particular, a towing vehicle, configured for trailer operations

### BACKGROUND OF THE INVENTION

A generic electropneumatic service brake device is known from DE 10 2007 020 881 A1. This publication describes a typical architecture of an electronically controlled brake system (EBS), including a foot brake module (FBM), electronic service brake control (EBS-ECU) and intelligent 1-channel and 2-channel pressure control modules at a front axle and a rear axle, which implement sensitive electronic control of the brake pressures at all axles and at the trailer and all known brake functions, however, the unit is relatively expensive. On the other hand, conventionally controlled brake systems are known, which facilitate all brake functions that are relevant for driving dynamics like ABS, ASR, ESP, or emergency brake ABS, however, these systems do not facilitate sensitive brake force control per axle due to the open circuit pressure control.

### BRIEF SUMMARY OF THE INVENTION

Thus, it is an object of the invention to provide an electropneumatic service brake device which offers a high level of functionality with low complexity. A towing vehicle with the electropneumatic service brake device shall also be provided, wherein the towing vehicle is configured for trailer operations.

The object is achieved by the features of the independent claims.

The invention relates to an electropneumatic service brake device for a towing vehicle configured for trailer operations, the service brake device comprising:
a) at least one pneumatic service brake cylinder BZ1, loadable with a first operating pressure p1 and at least one second pneumatic service brake cylinder BZ2, loadable with a second service brake pressure p2,
b) a foot brake actuation device,
c) a pneumatic foot brake valve device, including a first pneumatic channel, provided and configured to generate a first control pressure Stp1 as a function of an actuation of the foot brake actuation device, and a second pneumatic channel, provided and configured to generate a second control pressure Stp2 as a function of an actuation of the foot brake actuation device,
d) an electrical brake request signal generator, provided and configured to generate an electrical brake request signal as a function of an actuation of the foot brake actuation device,
e) an electronic service brake control EBS-ECU, provided and configured to generate an electrical control signal as a function of the electrical brake request signal, wherein the electrical control signal represents a nominal service brake pressure,
f) a first electropneumatic solenoid valve device 2C-EVO, provided with compressed air from a first compressed air storage and provided and configured to be electrically controllable by the electrical control signal or pneumatically controllable by the first control pressure Stp1 to control a first service brake pressure p1 for the at least one first pneumatic brake cylinder BZ1 at a first output connection, wherein the first service brake pressure p1 is modulated in particular by a first pressure control valve PCV1,
g) a second electropneumatic solenoid valve device FAM, provided with compressed air from a second compressed air storage and controlled by the electronic service brake control EBS-ECU and configured to generate the second service brake pressure p2 for the at least one second service brake cylinder BZ2 at a second output connection,
h) at least one second pressure control valve PCV2, controllable by the electronic service brake control EBS-ECU to modulate the second service brake pressure p2 for the at least one second service brake cylinder BZ2.

The invention is characterized in that
i) the second electropneumatic solenoid valve device FAM is configured and controlled by the electronic service brake control EBS-ECU, so that the second service brake pressure p2 for the at least one second service brake cylinder BZ2
   i1) is generated in a first operating mode as a first option as a function of the first service brake pressure p1 or as a second option as a function of the second control pressure Stp2, wherein the first option and the second option are both implemented, or
   i2) is provided in a second operating mode by the second supply pressure pV2, provided in the second compressed air storage (17), in particular, volume-augmented by a relay valve RV.

The first pressure control valve PCV1 and the second pressure control valve PCV2 are advantageously configured as typical ABS pressure control valves, respectively including two membrane valves, configured as inlet and outlet valves, respectively electrically pre-controlled by a 2/2-way solenoid valve. The first pressure control valve PCV1 and the second pressure control valve PCV2 modulate, this means, periodically decrease, maintain, or increase the first service brake pressure p1 and the second service brake pressure p2 as required, this means when driving instability exists.

The electropneumatic service brake device according to the invention is a “hybrid brake system”, since it includes a portion of a typical electronically controlled brake system (EBS), embodied by the electronic service brake control EBS-ECU and the first electropneumatic solenoid valve device which is formed, in particular, by a single-channel or multi-channel pressure control module. On the other hand, the first electropneumatic solenoid valve device differs from a pressure control module used in an EBS, since it includes fewer components and different components compared to the EBS pressure control module. This generates significant cost savings on the one hand side.

On the other hand side, the electropneumatic service brake device according to the invention fulfills all requirements with respect to redundant control of the brake circuit. The electropneumatic service brake device according to the invention provides a series of control and regulation options, in particular, with reference to stability and/or driving dynamics regulation.

In particular, the two options in the first operating mode implement the required two-circuit configuration of the service brake at the second brake cylinders, supplied with the service brake pressure by the second electropneumatic solenoid valve device FAM, wherein the second brake cylinders are arranged e.g. at a front axle of the towing vehicle. When the first brake circuit in which the first service brake pressure p1, in particular for the rear axle brake cylinders, is generated as the first option and which is, therefore, in particular, a rear axle brake circuit, fails due to a leakage in the compressed air supply from the first compressed air storage, this first service brake pressure p1 cannot be generated anymore at all or cannot be generated in a sufficient manner so that the first option does not exist anymore. However, in this case, the second service brake pressure p2 can be generated as a second option by the second electropneumatic solenoid valve device FAM as a function of the second control pressure Stp2. In both cases, the first option and in the second option, the second service brake pressure p2 can be modulated by the at least one second pressure control valve PCV2, in particular, controlled by the electronic service brake control EBS-ECU, in order to perform a stability and/or driving dynamics control like ABS-ASR and/or ESP. The first option and the second option being jointly provided means that both options are executable all the time as a matter of principle due to the required dual-circuit capability. As a matter of principle, the second electropneumatic solenoid valve device FAM can be configured and controlled by the electronic service brake control EBS-ECU, so that a switch from the first option to the second option and vice versa is possible.

In particular, operating in the first operating mode, the second service brake pressure p2, according to the first option, can correspond to the first service brake pressure p1, and/or according to the second option can correspond to the second control pressure Stp2, e.g. respectively, volume-augmented by at least one relay valve and/or also without the volume augmentation.

The provided first and second pressure control valves PCV1 and PCV2 provide a modulation of the first and second service brake pressures p1 and p2, so that stability and driving dynamics control of the towing vehicle can be provided. Optionally, the trailer brake pressure can also be modulated by a third pressure control valve PCV3 in the sense of a stability and/or driving dynamics control, as long as a trailer control module TCM is not already controlled for this purpose.

The provided second operating mode further increases failure safety of the service brake and a circuit separation, while still providing stability or driving dynamics control. There may be a case, where switching from the first option to the second option or vice versa is not possible in the first operating mode for technical reasons, e.g. when a solenoid valve performing this switching fails. Then, the respective brake circuit could still be operated using the second operating mode. Also, in this case, the second service brake pressure p2 can be modulated by the at least one second pressure control valve PCV2, in particular, controlled by the electronic service brake control EBS-ECU, in order to perform, e.g. a stability and/or driving dynamics control like ABS, ASR, and/or ESP. Switching from the first operating mode to the second operating mode can be performed, in particular, by providing current or by not providing current to at least one magnetic valve of the second electropneumatic solenoid valve device FAM, in particular, controlled by the electronic service brake control EBS-ECU.

Since the second electropneumatic solenoid valve device FAM is advantageously configured as a unit and includes, in particular, only two solenoid valves, in particular, two 3/2-way solenoid valves and optionally also a relay valve, but is configured differently from a typical pressure control module, without integrated backup solenoid valve (2/2-way solenoid valve) and/or without integrated electronic control device and/or without an integrated pressure sensor, the configuration of the second electropneumatic solenoid valve device FAM is simpler compared to a 1-channel pressure control module typically installed at the front axle.

According to an advantageous embodiment, the second electropneumatic solenoid valve device FAM can be configured and controlled by the electronic service brake control EBS-ECU, so that the first option or the second option is pre-set in the second operating mode. This can be implemented by the switching position in a configuration where the second electropneumatic solenoid valve device FAM includes at least one spring-preloaded solenoid valve, wherein the spring preload acts in the switching position or by a preset current supply to the solenoid valve.

As recited supra, the electronic service brake control EBS-ECU can include at least one stability or driving dynamics control, wherein:
a) the second service brake pressure p2 is generated for the at least one second service brake cylinder BZ2 during a braking process without activated stability and/or driving dynamics control in the first operating mode and e.g. according to the second option, alternatively according to the first option, and
b) the second service brake pressure p2 is generated for the at least one second service brake cylinder BZ2 during a braking process with activated stability and/or driving dynamics control in the second operating mode.

Advantageously, the stability and/or driving dynamics control can include at least one of the following controls: anti wheel lock control (ABS), traction control (ASR), driving stability control (ESP). This enumeration, however, is not exclusive. The term electronic stability control is interpreted broadly and includes any, and in particular any automatic interaction with the driving properties of the towing vehicle in order to provide its driving stability.

Advantageously, also the second electropneumatic solenoid valve device FAM can be included in a unit including a first pneumatic connection P41 for the second control pressure Stp2, and a second pneumatic connection P42 for the first service brake pressure p1, a supply connection for the second supply pressure provided in the second compressed air storage, the second output connection for the second operating pressure p2, and at least one electrical control connection for control by the electronic service brake control EBS-ECU.

Advantageously, the second electropneumatic solenoid valve device FAM includes at least:
a) at least one first 3/2-way solenoid valve MV1, and at least one second 3/2-way solenoid valve MV2, in particular only those two solenoid valves, wherein
b) a first input of the first 3/2-way solenoid valve MV1 is connected with the first pneumatic connection P41, and a second input is connected with the second pneumatic connection P42, and a first output is connected with a first input of the second 3/2-way solenoid valve MV2, and wherein
c) a second input of the second 3/2-way solenoid valve MV2 is connected with the supply connection, and the second service brake pressure p2 is controlled at the second output connection as a function of a pressure provided at a second output of the second 3/2-way solenoid valve MV2.

Optionally,
a) the first 3/2-way solenoid valve MV1 can connect the first output in a first switching position MV1/I with the first input of the first 3/2-way solenoid valve MV1 and in a second switching position MV1/II with the second input of the first 3/2-way solenoid valve MV1, and
b) the second 3/2-way solenoid valve MV2 can connect the second output in a first switching position MV2/I with the first input of the second 3/2-way solenoid valve MV2, and in a second switching position MV2/II with the second input of the second 3/2-way solenoid valve MV2.

Advantageously, current to the first 3/2-way solenoid valve MV1 is cut by the electronic service brake control EBS-ECU, in order to put it into its first switching position MV1/I, and provided with current in order to assume its second switching position MV1/II. Further advantageously, current to the second 3/2-way solenoid valve MV2 is cut by the electronic service brake control EBS-ECU, in order for it to assume a first switching position MV2/I and current is provided in order for it to assume its second switching position MV2/II. Instead of the electronic service brake control EBS-ECU or in addition thereto, any electronic control can perform current interruption and/or current supply to the 3/2-way solenoid valves MV1 and MV2.

A relay valve RV can be connected between the second output of the second 3/2-way solenoid valve MV2 and the second output connection, wherein the relay valve RV is supplied with compressed air from the second compressed air storage and controlled by the pressure provided at the second output of the second 3/2-way solenoid valve MV2. This relay valve RV can also provide the volume augmentation described supra for the second control pressure Stp2 and/or for the first service brake pressure p1, However, the relay valve is optional.

According to an advantageous embodiment of the invention, at least one throttle can be arranged in a flow connection between the second input of the first 3/2-way solenoid valve MV1 and the second pneumatic connection of the second electropneumatic valve device FAM. The throttle prevents a compressed air flow from one brake circuit into another brake circuit, e.g., in case of a leakage of a solenoid valve of the second electropneumatic solenoid valve device FAM.

The first electropneumatic solenoid valve device 2C-EVO can include a pressure regulation module with a local control device and at least one pressure sensor, which renders the first service brake pressure p1 controllable to the nominal service brake pressure. The pressure control module additionally includes an inlet/outlet valve combination and a relay valve pneumatically controlled by the inlet/outlet valve combination. The pressure control module is controlled, in particular, at an electrical connection by an electrical control signal fed by the electronic service brake control and controlled by the first control pressure Stp1 at a pneumatic connection. The pressure sensor integrated in the pressure control module then measures the actual service brake pressure put out by the relay valve and reports a corresponding value to the local integrated control device which then controls the inlet/outlet valve combination, so that the first actual service brake pressure is adjusted to the nominal service brake pressure, which is represented by the electrical control signal. Primarily, the pressure control module is electrically controlled by the electrical control signal. When the electrical system fails the pneumatic control is performed by the second pneumatic control pressure, which is then fed through the open electrically non-powered backup solenoid valve to the control connection of the relay valve, so that the relay valve then generates the first service brake pressure p1. The pressure control module by itself therefore corresponds to a typical pressure control module that is known in the art.

Advantageously, the first electropneumatic solenoid valve device 2C-EVO is formed by a 2-channel pressure regulation module, wherein each channel includes the components described supra and controls the first service brake pressure p1 at a respective wheel of an axle, advantageously at a rear axle.

According to an advantageous embodiment, the electrical brake request signal generator includes:
a) the electronic service brake control EBS-ECU and at least one pressure sensor PS1, PS2, provided and configured to detect the first control pressure Stp1 and/or the second control pressure Stp2, wherein the electronic service brake control EBS-ECU generates the electronic brake request signal as a function thereof, and/or
b) the electronic service brake control EBS-ECU and an electrical brake value generator of a foot brake module FBM that detects an actuation level of the foot brake actuation device, wherein the electronic service brake control EBS-ECU generates the electric brake request signal as a function thereof.

A first pressure control module PCV1, controllable by the electronic service brake control EBS-ECU, can be arranged between the first electropneumatic solenoid valve device 2C-EVO and the at least one brake cylinder BZ1, wherein the first pressure control valve PCV1 is arranged and configured to modulate the first service brake pressure p1.

Analogously, the second pressure control valve PCV2, electrically controllable by the electronic service brake control EBS-ECU, can be arranged between the second electropneumatic solenoid valve device FAM and the at least one second brake cylinder BZ2, wherein the second pressure control valve PCV2 is provided and configured to modulate the second service brake pressure p2.

The electropneumatic service brake device can include the following for generating a trailer service brake pressure for brakes of the trailer:
a) an electropneumatic trailer control module TCM including at least one solenoid valve which is provided by the first compressed air storage or by the second compressed air storage or by another compressed air storage with compressed air and which is controllable by the electronic service brake control EBS-ECU electrically and controllable pneumatically by the first control pressure Stp1 or by the second control pressure Stp2,
b) a trailer control valve TCV, provided and configured to be pneumatically controlled by the first service brake pressure p1 or by the second service brake pressure p2 or by the first control pressure Stp1, or by the second control pressure Stp2 and to be provided with compressed air by the first compressed air storage or by the second compressed air storage or by another compressed air storage.

In case a) modulation of the trailer brake pressure can be performed as stability and/or driving dynamics control by a corresponding control of the electropneumatic trailer control module TCM by the electronic service brake control, since the electropneumatic trailer control module TCM includes an inlet/outlet solenoid valve combination which facilitates this modulation.

In case b) a third pressure control valve PCV3 can be connected upstream of the trailer control valve TCV in order to modulate at least the second service brake pressure p2, in particular, in a sense of a stability or driving dynamics control. Using the third pressure control valve PCV3, the second service brake pressure p2 is modulated, this means periodically lowered, maintained, and increased, wherein the second service brake pressure forms a control pressure for the trailer control valve PCV as required, this means in a case of driving instability.

A module can be provided in the electropneumatic service brake device wherein the module includes at least the electronic service brake control EBS-ECU and the first electropneumatic solenoid valve device 2C-EVO, in particular, the pressure control module. Thus, the routines of the service brake control can be integrated into the local control device of the pressure control module.

Alternatively, at least the electronic service brake control EBS-ECU can also be implemented as a separate and uniform component. Further alternatively, the control and regulation routines of the electronic service brake control EBS-ECU can also be distributed among several electronic control devices. Additionally, at least a portion of the control and regulation routines of the electronic service brake control EBS-ECU, which control and regulate the electropneumatic service brake device, can be implemented in electronic control devices which otherwise perform a function that differs from a brake control and regulation, like, e.g. a parking brake control, a compressed air generation control, a stability control, and/or an air suspension control.

In the electropneumatic service brake device,
a) a first brake circuit can include at least the first solenoid valve device 2C-EVO, the first pneumatic channel, the at least one first pressure control module PCV1, and the at least one first service brake cylinder BZ1, and
b) a second brake circuit can include at least the second solenoid valve device FAM, the second pneumatic channel, the at least one second pressure control valve PCV2, and the at least one second service brake cylinder BZ2.

The invention also relates to a vehicle, in particular, a towing vehicle configured for trailer operations and comprising the electropneumatic service brake device described supra.

### BRIEF DESCRIPTION OF THE DRAWINGS

The invention is now described based on an advantageous embodiment with reference to drawing figures, wherein:

FIG. 1 illustrates a schematic diagram of a first embodiment of an electropneumatic service brake device, including a front axle module FAM, a purely pneumatic foot brake valve FBV, and a purely pneumatic trailer control valve TCV;

FIG. 2 illustrates a schematic diagram of a second embodiment of an electropneumatic service brake device according to the invention, including the front axle module FAM, an electropneumatic foot brake module FBM, and the purely pneumatic trailer control valve TCV.

FIG. 3 illustrates a schematic diagram of a third embodiment of an electropneumatic service brake device according to the invention, including the front axle module FAM, the electropneumatic foot brake module FBM, and an electropneumatic trailer control module TCM;

FIG. 4 illustrates an advantageous embodiment of the front axle module FAM.

### DETAILED DESCRIPTION OF THE INVENTION

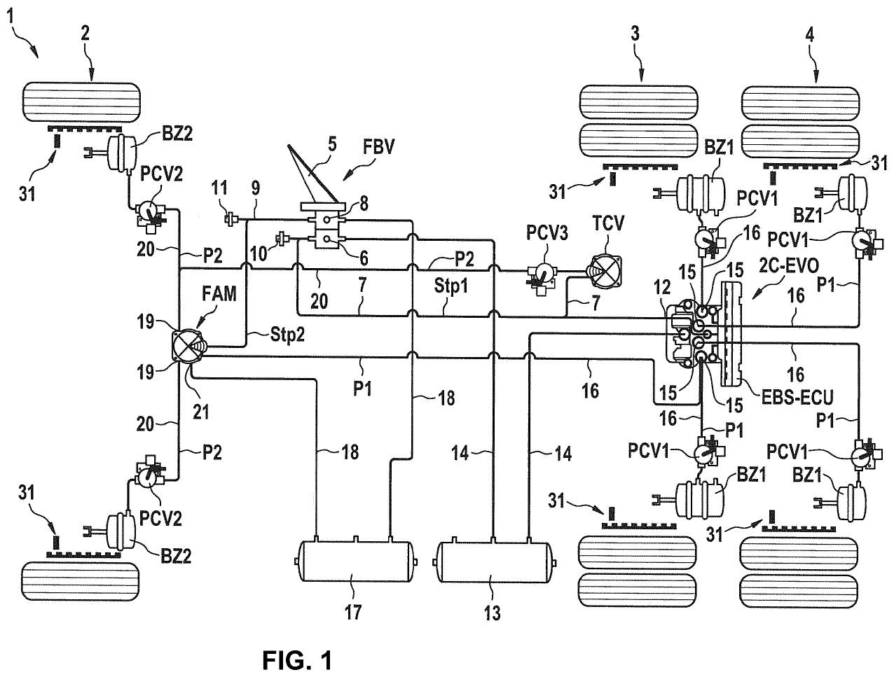

FIG. 1 illustrates a schematic diagram of a first embodiment of an electropneumatic service brake device 1 according to the invention, including a first electropneumatic solenoid valve device 2C-EVO, a second electropneumatic solenoid valve device FAM, and a purely pneumatic foot brake valve FBV, and a purely pneumatic trailer control valve TCV. The electropneumatic service brake device 1 is integrated into a towing vehicle, including a steered front axle 2 and two rear axles, a first rear axle 3 and a second rear axle 4.

Two first pneumatic service brake cylinders BZ1, loadable with a first service brake pressure p1, are arranged at the front axle 2 and activate the first wheel brakes at the front axle. Analogously, two respective pneumatic service brake cylinders BZ2, loadable by a second service brake pressure p2, are arranged at two rear axles 3, 4 and are configured to activate the second wheel brakes at the wheels of the rear axle. So-called combi cylinders, including a second service brake cylinder BZ2 and a spring accumulator brake cylinder, are arranged at the first rear axle 3 in order to implement a parking brake using the spring-accumulator brake cylinders.

The purely pneumatic foot brake valve FBV is provided with a foot brake actuation device 5 and includes a first foot brake valve component, including a first pneumatic channel 6 that is provided and configured to generate a first control pressure Stp1 in a first control conduit 7 as a function of an actuation of the foot brake actuation device 5. The foot brake valve FBV additionally includes a second foot brake valve component, including a second pneumatic channel 8, configured and provided to generate a second control pressure Stp2 in a second control conduit 9 as a function of an actuation of the foot brake actuation device 5.

An electrical brake request signal generator is additionally provided which includes two pressure sensors, a first pressure sensor 10 in the first control conduit 7, configured to detect the first control pressure Stp1, and a second pressure sensor in the second control conduit 9, configured to detect the second control pressure Stp2 and to control corresponding pressure signals into an electronic service brake control EBS-ECU through signal conductors. Since the first control pressure Stp1 and the second control pressure Stp2 are generated as a function of an actuation of the foot brake actuation device 5, the output signals of the pressure sensors 10, 11 are independent from an actuation and can therefore be interpreted as electronic brake request signals in the electronic service brake control EBS-ECU or computed into electronic brake request signals. The values for the first control pressure Stp1 and the second control pressure Stp2 can be subjected to a plausibility analysis, comparing them to each other in the electronic service brake control EBS-ECU. The two control pressures can also be averaged or weighted. A singular pressure sensor can also be provided instead of two pressure sensors 10, 11, wherein the single pressure sensor either measures the first control pressure Stp1 or the second control pressure Stp2.

The electronic service brake control EBS-ECU is provided and configured to generate an electrical control signal as a function of the pressure signals or as a function of the electrical brake request signal derived therefrom in the electronic service brake control EBS-ECU, wherein the electrical control signal represents a nominal service brake pressure for the first service brake pressure p1 and the second service brake pressure p2.

The first electropneumatic solenoid valve device 2C-EVO is configured to regulate the first service brake pressure p1 to the nominal service brake pressure at the two rear axles. Thus, the first electropneumatic valve device 2C-EVO can be configured, e.g., as a two-channel pressure regulation module with an integrated electronic control device and a pressure sensor per channel. An electrical connection of the two-channel pressure control module is connected with the electronic service brake control EBS-ECU through a signal conductor in order to feed the electrical control signal to the two-channel pressure regulation module.

The two-channel pressure regulation module includes the following per channel: an inlet/outlet valve combination, a relay valve pneumatically controlled by the inlet/outlet combination, and a backup solenoid valve for the pneumatic control. The two-channel pressure regulation module is controlled at an electrical connection by the electrical control signal fed by the electronic service brake control EBS-ECU, electronically and pneumatically controlled at a pneumatic connection 12 by the first control pressure Stp1 run in the first control conduit 7. The pressure sensors integrated in the two-channel pressure regulation module measure actual service brake pressures put out by the relay valves and report respective values to the integrated electronic control unit, which controls the inlet/outlet valve combinations per channel, so that the two first actual service brake pressures p1 are adjusted to the nominal service brake pressure which is represented by the electrical control signal.

Preferably, the two-channel pressure regulation module is electrically controlled by the electrical control signal. In case the electrical system fails, the pneumatic control is performed by the first pneumatic control pressure Stp1, which is then controlled through the open no-current backup solenoid valves to the control connections of the relay valves, so that the relay valves then generate the first service brake pressure p1. The two-channel pressure regulation module is arranged, e.g. at the first rear axle 3, however, it regulates the first service brake pressure p1 at the second service brake cylinders BZ2 of the first and second rear axle 3, 4, wherein a respective channel is associated with the two wheels at a vehicle side. The two-channel pressure control module is supplied with compressed air from a first compressed air storage 13 through a first supply conduit 14. The two-channel pressure control module is a typical two-channel pressure control module that is known in the art.

First brake lines run between first output connections 15 of the two-channel pressure regulation module, wherein a first pressure control module PCV1 is respectively arranged in each of the first brake lines and controlled by the electronic service brake control EBS-ECU to modulate the first service brake pressure p1, in particular, in a sense of a stability and/or driving dynamics control like ABS, ASR, and/or ESP.

In this case, the electronic service brake control EBS-ECU and the two-channel pressure control module form a unit, wherein the routines of the service brake control/regulation including the stability and/or driving dynamics control are implemented in the integrated electronic control device of the two-channel pressure regulation module that also performs the pressure control.

A second electropneumatic solenoid valve device FAM is additionally provided and supplied with compressed air from a second compressed air storage 17 through a second supply conduit 18 and electrically controlled by the electronic service brake control EBS-ECU, so that the second electropneumatic solenoid valve device puts out the second service brake pressure p2 for the two second service brake cylinders BZ2 at the front axle at second output connections 19. Thus, second pressure control valves PCV2 are also arranged in second brake conduits run between the second output connections 19 and the second service brake cylinders BZ2, wherein the second pressure control valves PCV2 are controllable by the electronic service brake control EBS-ECU in order to modulate the second service brake pressure p2, in this case, also, in particular, in a sense of the stability and driving dynamics control recited supra.

Advantageously, the second electropneumatic solenoid valve device FAM is a unit arranged at the front axle 2 that includes a first pneumatic connection P41 for the second control pressure Stp2 and a second pneumatic connection P42 for the first service brake pressure p1, a supply connection 21 for the second supply conduit 18, run from a second compressed air storage 17, the second output connections 19 for the second service brake pressure p2 and an electrical control connection 22 for electrical control by the electronic service brake control EBS-ECU. Therefore, the second electropneumatic solenoid valve device FAM is electrically controllable and twice pneumatically controllable, wherein each pneumatic control forms an individual pneumatic brake circuit.

A rear axle brake circuit in the electropneumatic service brake device 1 includes the first compressed air storage 13, the first electropneumatic solenoid valve device 2C-EVO, the first pneumatic channel 6 of the foot brake valve FBV, the first pressure control valves PCV1, and the first service brake cylinders BZ1. A front axle brake circuit includes the second compressed air storage 17, the second electropneumatic solenoid valve device FAM, the second pneumatic channel 8 of the foot brake valve FBV, the second pressure control valves PCV2, and the second service brake cylinders BZ2. Therefore, both brake circuits are controlled electrically and pneumatically.

The embodiment of the electropneumatic service brake device 1 of FIG. 1 includes a trailer control valve TCV, configured to control a trailer brake pressure for the brakes of the trailer, wherein the trailer control valve is provided and configured to be pneumatically controlled and supplied with compressed air from an additional compressed air storage into two pneumatic circuits, namely, on the one hand, by the second service brake pressure p2 in the second brake conduit 20 and by the first control pressure Stp1 in the first control pressure conduit. A third pressure control valve PCV3 is advantageously connected in a second brake conduit 20 running from a second output connection 19 of the second electropneumatic solenoid valve device FAM to a pneumatic connection of the trailer control module TCV, wherein the third pressure control valve is controlled by the electronic service brake control EBS-ECU to modulate the second service brake pressure p2, in particular, to provide stability or driving dynamics control. This also facilitates modulating the trailer brake pressure generated by the trailer control valve PCV, based on the second service brake pressure p2 in order to provide stability and/or driving dynamics control.

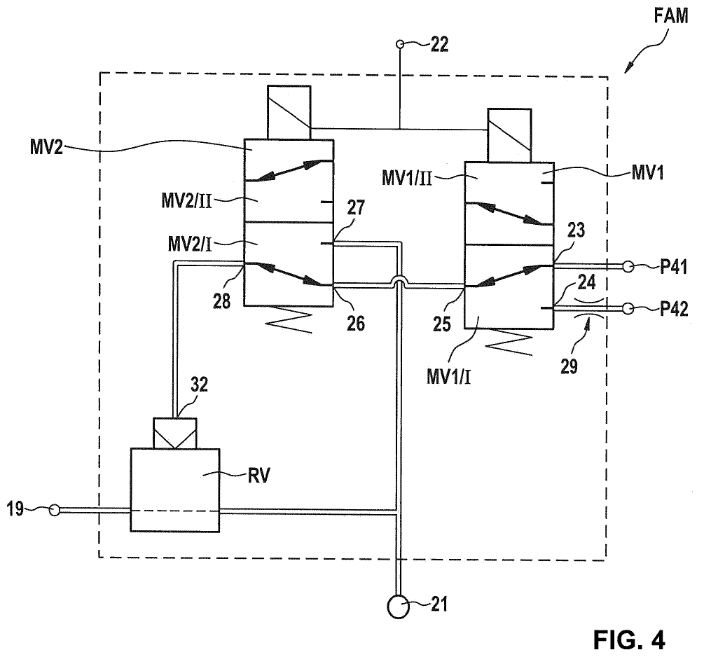

As evident from FIG. 4, the second electropneumatic solenoid valve device FAM only includes two solenoid valves, namely, a first 3/2-way solenoid valve MV1 and a second 3/2-way solenoid valve MV2. At the first 3/2-way solenoid valve MV1, a first input 23 is connected with the first pneumatic connection P41, and a second input 24 is connected with the second pneumatic connection P42, and a first output 25 is connected with a first input 26 of the second 3/2-way solenoid valve MV2. At the second 3/2-way solenoid valve MV2, a second input 27 is connected with the supply connection 21, and the second service brake pressure p2 is controlled at the second output connections 19 as a function of a pressure provided at a second output 28 of the second 3/2-way solenoid valve MV2.

Thus, the second 3/2-way solenoid valve MV1 can connect its first output 25 in a first switching position MV1/I with its first input 23 and in a second switching position MV1/II with its second input 24. The second 3/2-way solenoid valve connects its second output 28 in a first switching position MV2/I with its first input 26 and in a second switching position MV2 with its second input 27.

Advantageously, the first 3/2-way solenoid valve MV1 is controlled by the electronic service brake control EBS-ECU so that it is without current, in order to assume to first switching position MV1/I and provided with current to assume the second switching position MV1/II. An electrical failure has the effect that the second electropneumatic solenoid valve device FAM is controlled by the second control pressure Stp2 as illustrated in FIG. 4, wherein the second control pressure is generated in the second pneumatic channel 8 of the foot brake valve FBV.

A relay valve RV is connected between the second output 28 of the second 3/2-way solenoid valve MV2 and the second output connections 19, wherein the relay valve RV is supplied with compressed air from the second compressed air storage 17 and controlled at its control connection 20 by the pressure provided at the second output 28 of the second 3/2-way solenoid valve MV2. This optional relay valve RV then provides a volume augmentation of the second control pressure Stp2 or of the first service brake pressure p1, depending on a switching position of the first 3/2-way solenoid valve MV1.

A throttle 29 can be optionally provided in a flow connection between the second input 24 of the first 3/2-way solenoid valve MV1 and the second pneumatic connection P42 of the second electropneumatic solenoid valve device FAM. The throttle 29 helps to prevent a compressed air flow from the pneumatic brake circuit that is controlled by the first service brake pressure p1 into the other pneumatic brake circuit that is controlled by the second control pressure Stp2, for example, when there is a leak within the first 3/2-way solenoid valve MV1.

Improving upon the embodiment of the second electropneumatic solenoid valve device FAM, control is provided by the electronic service brake control EBS-ECU, so that the second service brake pressure p2 is generated in a first operating mode and in a first option as a function of the first service brake pressure p1, and in a second option as a function of the second control pressure Stp2. The two options are illustrated in the embodiment of FIG. 4 by the two switching positions MV1/I and MV1/II of the first solenoid valve MV1.

The second electropneumatic solenoid valve device FAM is controlled by the electronic service brake control EBS-ECU in a second operating mode, so that the second service brake pressure p2 is formed by the second supply pressure pV2 provided in the second compressed air storage 17 and optionally volume-augmented by the relay valve RV by the second supply pressure pV2. As evident from FIG. 4, the second operating mode is generated by switching the second 3/2-way solenoid valve MV2 from the first switching position MV2/I shown in FIG. 4 into the second switching position MV2/II.

This yields a multitude of redundancy and control and regulation options with respect to the service brake pressures p1, p2.

The two options implement the required dual-circuit configuration of the service brake at the second brake cylinders BZ2 provided with the service brake pressure by the second electropneumatic solenoid valve device FAM in the first operating mode, wherein the second brake cylinders BZ2 are arranged at the front axle 2 of the towing vehicle. When the rear axle brake circuit that generates the first service brake pressure p1 in the first option fails, e.g., due to a leakage in the first compressed air storage 13, the first service brake pressure p1 cannot be generated anymore or cannot be generated anymore to a sufficient extent so that the first option does not exist anymore. Then, however, the second service brake pressure p2 can be generated by the second electropneumatic solenoid valve device FAM as a function of the second control pressure Stp2 as a second option. In both cases, the first option and the second option, the second service brake pressure p2 can be modulated by the second pressure control valves PCV2, controlled by the electronic service brake control EBS-ECU in order to perform a stability and/or driving dynamics control like, e.g., ABS, ASR, and/or ESP. Therefore, the second electropneumatic solenoid valve device FAM facilitates a switching from the first option to the second option and vice versa by switching the first 3/2-way solenoid valve MV1 advantageously by the electronic service brake control EBS-ECU. The switching is performed by providing current or not providing current to the first 3/2-way valve MV1, in particular, by the electronic service brake control EBS-ECU.

The second service brake mode increases fail safety of the service brake even more and provides circuit separation while still having the ability to perform stability or driving dynamics control. There may be a situation where a switching from the first option to the second option or vice versa is not possible in the first operating mode, because the first 3/2-way solenoid valve MV1 used for the switching has failed, e.g., by being stuck. Then, the second service brake mode can still operate the front axle brake circuit in that, e.g. the second 3/2-way solenoid valve MV2 is switched from a first switching position MV2/I, illustrated in FIG. 4, which is advantageously provided when no current is provided to the second 3/2-way solenoid valve MV2, so that this solenoid valve is switched into its second switching position MV2/II by providing current, in particular, through the electronic service brake control EBS-ECU. Also in this case, the second service brake pressure p2 generated by the supply pressure provided in the second compressed air storage 17 can be modulated by the second electronic service brake control EBS-ECU as stability and/or driving dynamics controls like ABS, ASR, and/or ESP that controls the pressure control valves PCV2 in order to prevent stability and/or driving dynamics control. Switching from the first operating mode to the second operating mode and vice versa is, therefore, performed, in particular, by providing current to or cutting current off from the second 3/2-way solenoid valve MV2, in particular, by the electronic service brake control EBS-ECU.

In order to detect errors or failure in the 3/2-way solenoid valves MV1 and MV2, pressure leaks, excessively low service brake pressures p1, p2, electrical errors or failures, monitoring routines can be provided. For example, self-monitoring of the integrated control device of the two-channel pressure control module 2C-EVO and/or the electronic service brake control EBS-ECU can be used to detect the functionality of the components, and the affected components can then be shut down, performing a fail-silent strategy. Then, the first service brake pressure p1 cannot be generated electrically anymore. However, the redundant pneumatic control of the two-channel pressure regulation module 2C-EVO that is still functional assures through the first control pressure Stp1 that the first service brake pressure p1 can still be provided.

When the error is caused by a leakage in the rear axle brake circuit, which can be detected by the electronic service brake control EBS-ECU from the decreasing first control pressure Stp1 (signal of the first pressure sensor 10), then the current to the first 3/2-way solenoid valve MV1 is cut off by the electronic service brake control EBS-ECU, so that the first 3/2-way solenoid valve MV1 is automatically switched into its first switching position MV1/I by a spring load. This has the effect that the second electropneumatic solenoid valve device FAM is controlled by the second control pressure Stp2 as shown in FIG. 4.

The advantageous feature that the two 3/2-way solenoid valves, MV1 and MV2, are spring-loaded in one of their switching positions and assume this switching position automatically when current is cut off, is used to assume the respective spring-loaded switching positions when the power fails, in order to provide an additional generation of the second service brake pressure p2.

As recited supra, at least one stability and/or driving dynamics control is provided in the electronic service brake control EBS-ECU, like, e.g., anti wheel lock control (ABS), traction control (ASR), and/or driving stability control (ESP). The electronic service brake control EBS-ECU then receives signals of sensors like, e.g., wheel speed sensors 31, steering angle sensors, jaw rate sensors, and/or longitudinal and/or transversal acceleration sensors for this control.

When a braking process with activated stability or driving dynamics, control is performed, this means signals of the sensors are provided which indicate a driving instability of the towing vehicle and/or of the hooked-up trailer, the first pressure control valves PCV1 at the rear axles 3, 4 are controlled by the electronic service brake control EBS-ECU in order to modulate the first service brake pressure p1 so that driving stability is re-established.

When performing a braking with activated stability and/or driving dynamics control, the second service brake pressure p2 at the front axle 2 is generated in the second operating mode described supra. This second service brake pressure p2 is then modulated by the second pressure control valves PCV2 at the front axle 2 controlled by the brake control device EBS-ECU according to the respective stability interference, this means reduced periodically, maintained, or increased. When a braking process is performed without activated stability and/or driving dynamics control, this means that signals of the sensors are provided that indicate a driving stability of the towing vehicle and/or of the hooked-up trailer, the second service brake pressure p2 for the front axle is generated in the first operating mode described supra and generated e.g. according to the second option controlled by the second control pressure Stp2 at the second control input P42.

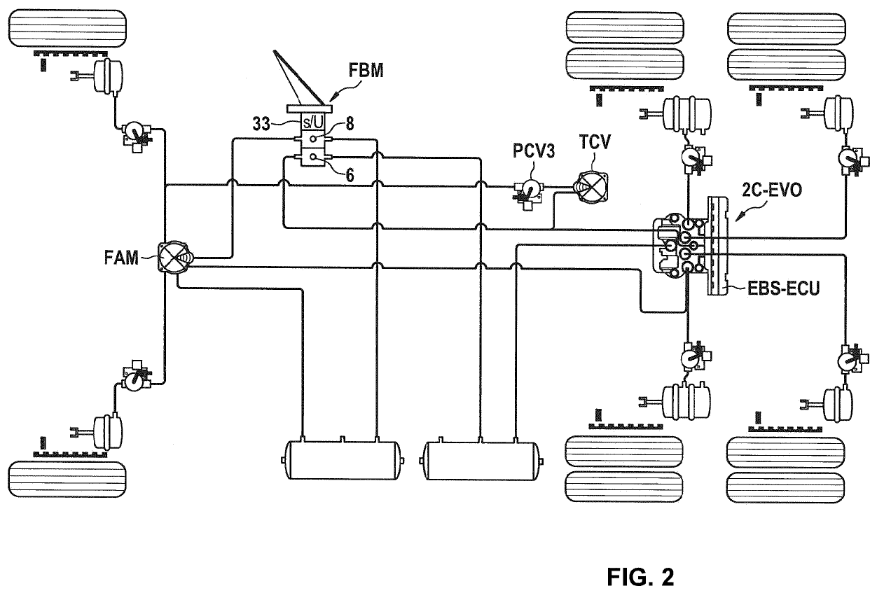

The embodiment illustrated in FIG. 2 differs from the embodiment illustrated in FIG. 1 in that a foot brake module FBM with integrated pneumatic foot brake valve FBV, including pneumatic channels 6 and 8 and additionally including an electrical channel 33, is provided, instead of a purely pneumatic foot brake valve FBV, and is configured to generate the electric brake request signal by at least one rotating potentiometer as an electric brake value encoder as a function of the detected actuation level of the foot brake actuation signal 5. Consequently, the two pressure sensors 10, 11, can then be omitted as well, which are arranged in FIG. 1 in the two control conduits 7 and 9 in order to generate the electrical brake request signal as a function of the two control pressures Stp1 and Stp2. The remaining components are configured as illustrated in FIG. 1.

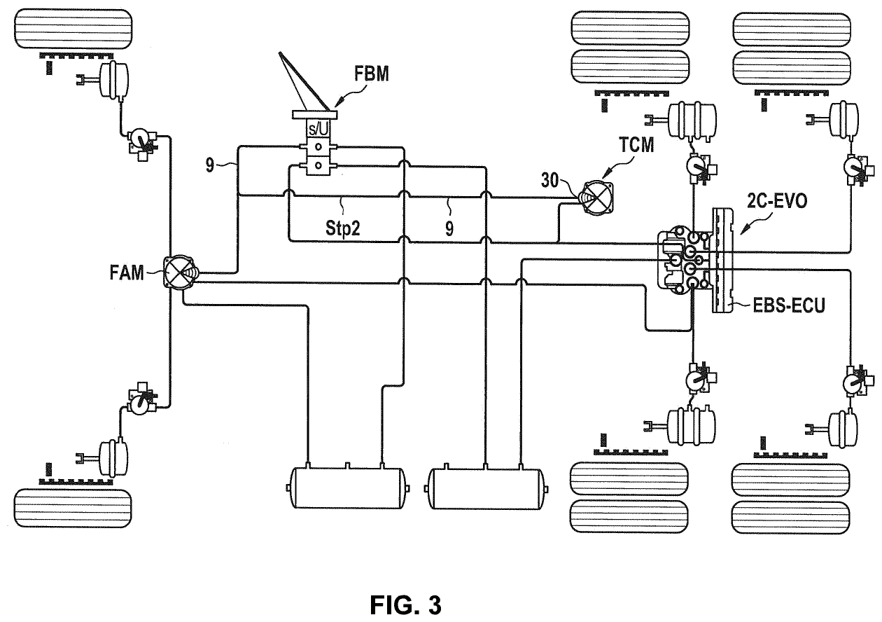

The embodiment of the electropneumatic service brake device illustrated in FIG. 3 improves upon the embodiment of FIG. 2. However, no pneumatic trailer control valve PCV for controlling the brakes of the trailer is provided, but an electropneumatic trailer control module (TCM) with electrical and pneumatic controllability similar to the pressure regulation module. Analogously thereto, the trailer control module TCM includes an integrated inlet/outlet valve combination and a relay valve pneumatically controlled by the inlet/outlet combination. Additionally, an electropneumatic backup valve and a pressure sensor can be integrated to measure the actual value of a trailer brake pressure put out at a coupling “brake”, wherein the actual value is then adjusted to a nominal trailer brake pressure by a pressure control, wherein the nominal brake pressure is provided to the trailer control module TCM by the electrical control signal at an electrical connection, wherein the electrical control signal is put out by the electronic service brake control EBS-ECU, which controls a superordinate electrical trailer brake circuit. When the superordinate electrical trailer brake circuit fails, the backup solenoid valve that is otherwise switched into its blocking position by the current switches into its pass-through condition in which the control connection of the integrated relay valve is connected with its pneumatic connection 30, which is loaded by the second control conduit 9, e.g., by the second control pressure Stp2. Then, the trailer control module TCM is pneumatically controlled by the second control pressure Stp2. The trailer control module TCM is then supplied with compressed air from an additional compressed air storage. Since the inlet-/outlet solenoid valve combination does not facilitate modulating the trailer brake pressure, and the modulation in a sense of a stability and/or driving dynamics control is also performed by the electronic service brake control (EBS-ECU) when required, the third pressure control valve PCV3 of the embodiments of FIG. 1 and FIG. 2 can be omitted.

Otherwise, the embodiments of FIGS. 2 and 3 perform the functions already described with reference to FIG. 1.

### REFERENCE NUMERALS AND DESIGNATIONS

1 Service brake device
2 Front axle
3 First rear axle
4 Second rear axle
Foot brake actuation device
6 First pneumatic channel
7 First control conduit
8 Second pneumatic channel
9 Second control conduit
10 First pressure sensor
11 Second pressure sensor
12 Pneumatic connection of 2C-EVO
13 First compressed air storage
14 First supply conduit
First output connections of 2C-EVO
16 First brake conduits
17 Second compressed air storage
18 Second supply conduit
19 Second output connections of FAM
20 Second brake conduits
21 Supply connection of FAM
22 Electrical control connection FAM
23 First input of MV1
24 Second input of MV1
25 First output of MV1
26 First input of MV2
27 Second input of MV2
28 Second output of MV2
29 Throttle
30 Pneumatic connection of TCM
31 Wheel speed sensor
32 Pneumatic control connection of relay valve of FAM
33 Electrical channel of FBM
2C-EVO First electropneumatic solenoid valve device
FAM Second electropneumatic solenoid valve device
FBV Pneumatic foot brake valve
TCV Pneumatic trailer control valve
TCM Electropneumatic trailer control module
PCV1 First pressure control valve
PCV2 Second pressure control valve
PCV3 Third pressure control valve
p1 First service brake pressure
p2 Second service brake pressure
Stp1 First control pressure
Stp2 Second control pressure
BZ1 First pneumatic service brake cylinder
BZ2 Second pneumatic service brake cylinder
EBS-ECU Electronic service brake control
P41 First pneumatic connection for second control pressure Stp2
P42 Second pneumatic connection for first brake pressure p1
RV Relay valve
MV1 First 3/2-way solenoid valve
MV1/I First switching position of MV1
MV1/II Second switching position of MV1
MV2 Second 3/2-way solenoid valve
MV2/I First switching position of MV2
MV2/II Second switching position of MV2

What is claimed is:

1. An electropneumatic service brake device (1) for a vehicle configured for trailer operations, the service brake device comprising:
at least one pneumatic service brake cylinder (BZ1), loadable with a first service brake pressure (p1), and at least one second pneumatic service brake cylinder (BZ2), loadable with a second service brake pressure (p2);
a foot brake actuation device (5);
a pneumatic foot brake valve device (FBV, FBM), including a first pneumatic channel (6), provided and configured to generate a first control pressure (Stp1) as a function of an actuation of the foot brake actuation device (5), and a second pneumatic channel (8), provided and configured to generate a second control pressure (Stp2) as a function of an actuation of the foot brake actuation device (5);
an electrical brake request signal generator (10, 11), provided and configured to generate an electrical brake request signal as a function of an actuation of the foot brake actuation device (5);
an electronic service brake control (EBS-ECU), provided and configured to generate an electrical control signal as a function of the electrical brake request signal, wherein the electrical control signal represents a nominal service brake pressure;
a first electropneumatic solenoid valve device (2C-EVO), provided with compressed air from a first compressed air storage (13) and provided and configured to be electrically controllable by the electrical control signal, or pneumatically controllable by the first control pressure (Stp1) to control a first service brake pressure (p1) for the at least one first pneumatic brake cylinder (BZ1) at least at a first output connection (15), wherein the first service brake pressure (p1) is modulated in particular by a first pressure control valve (PCV1);
a second electropneumatic solenoid valve device (FAM), provided with compressed air from a second compressed air storage (17) and controlled by the electronic service brake control (EBS-ECU) and configured to generate the second service brake pressure (p2) for the at least one second service brake cylinder (BZ2) at a second output connection (19); and
at least one second pressure control valve (PCV2), controllable by the electronic service brake control (EBS-ECU) to modulate the second service brake pressure (p2) for the at least one second service brake cylinder (BZ2),
wherein the second electropneumatic solenoid valve device (FAM) is configured and controlled by the electronic service brake control (EBS-ECU), so that the second service brake pressure (p2) for the at least one second service brake cylinder (BZ2)
is generated in a first operating mode as a first option as a function of the first service brake pressure (p1), or as a second option as a function of the second control pressure (Stp2), wherein the first option and the second option are both available concurrently, or
is provided in a second operating mode by the second supply pressure provided in the second compressed air storage (17).

2. The electropneumatic service brake device according to claim 1, wherein the second electropneumatic solenoid valve device (FAM) is configured and controlled by the electronic service brake control (EBS-ECU), so that the first option or the second option is preset in the first operating mode.

3. The electropneumatic service brake device according to claim 1, wherein the second electropneumatic solenoid valve device (FAM) is a unit that differs from a pressure regulation module by not having an integrated backup solenoid valve and/or an integrated electronic control device and/or an integrated pressure sensor.

4. The electronic service brake device according to claim 1, wherein the electronic service brake control (EBS-ECU) includes at least one stability or driving dynamics control,
Wherein the second service brake pressure (p2) is generated for the at least one second service brake cylinder (BZ2) during a braking process without activated stability and/or driving dynamics control in the first operating mode and according to the second option, and
wherein the second service brake pressure (p2) is generated in the second operating mode for the at least one second service brake cylinder (BZ2) during a braking process with activated stability and/or driving dynamics control.

5. The electropneumatic service brake device, according to claim 4, wherein the stability and/or driving dynamics control includes at least one of the following controls: anti wheel lock control (ABS), traction control (ASR), and/or a driving stability control (ESP).

6. The electropneumatic service brake device according to claim 1, wherein the second electropneumatic solenoid valve device (FAM) is configured as a unit, including a first pneumatic connection (P41) for the second control pressure (Stp2) and a second pneumatic connection (P42) for the first service brake pressure (p1), a supply connection (21) for the second supply pressure provided in the second compressed air storage (17), at least one second output connection (19) for the second service brake pressure (p2), and at least one electrical control connection (22), configured to be controlled by the electronic service brake control (EBS-ECU).

7. The electropneumatic service brake device according to claim 6, wherein the second electropneumatic solenoid valve device (FAM) includes
at least one first 3/2-way solenoid valve (MV1), and at least one second 3/2-way solenoid valve (MV2),
wherein a first input (23) of the first 3/2-way solenoid valve (MV1) is connected with the first pneumatic connection (P41), and a second input (24) is connected with the second pneumatic connection (P42), and a first output (25) is connected with a first input (26) of the second 3/2-way solenoid valve (MV2), and
wherein, a second input (27) of the second 3/2-way solenoid valve (MV2) is connected with the supply connection (21), and the second service brake pressure (p2) is controlled at the at least one second output connection (19) as a function of a pressure provided at a second output (28) of the second 3/2-way solenoid valve (MV2).

8. The electropneumatic service brake device according to claim 7,
wherein the first 3/2-way solenoid valve (MV1) connects its first output (25) in a first switching position (MV1/I) with its first input (23) and in a second switching position (MV1/II) with its second input (24), and
wherein the second 3/2-way solenoid valve (MV2) connects its second output (28) in a first switching position (MV2/I) with its first input (26), and in a second switching position MV2/II with its second input (27).

9. The electropneumatic service brake device according to claim 8, wherein the first 3/2-way solenoid valve (MV1) is cut off from electrical current by the electronic service brake control (EBS-ECU) in order to assume the first switching position (MV1/I) and is provided with electrical current to assume the second switching position (MV1/II).

10. The electropneumatic service brake device according to claim 7, wherein a relay valve (RV) is connected between the second output 28 of the second 3/2-way solenoid valve (MV2) and the at least one second output connection (19), wherein the relay valve (RV) is provided with compressed air by the second compressed air storage (17) and controlled by a pressure provided at the second output (28) of the second 3/2-way solenoid valve (MV2).

11. The electropneumatic service brake device according to claim 7, wherein at least one throttle (29) is arranged in a flow connection between the second input (24) of the first 3/2-way solenoid valve (MV1) and the second pneumatic connection (P42) of the second electropneumatic solenoid valve device (FAM).

12. The electropneumatic service brake device according to claim 1, wherein the first electropneumatic solenoid valve device (2C-EVO) includes a pressure regulation module including a local electronic control unit and a pressure sensor, configured to control the first service brake pressure (p1) to a nominal service brake pressure.

13. The electropneumatic service brake device according to claim 1, wherein the electrical brake request signal generator includes
the electronic service brake control (EBS-ECU) and at least one pressure sensor (10, 11), provided and configured to detect the first control pressure (Stp1) and/or the second control pressure (Stp2), wherein the electronic service brake control EBS-ECU generates the electronic brake request signal as a function thereof, and/or
the electronic service brake control (EBS-ECU) and an electrical brake value generator of a foot brake module (FBM) that detects an actuation level of the foot brake actuation device, wherein the electronic service brake control (EBS-ECU) generates the electric brake request signal as a function thereof.

14. The electropneumatic service brake device according to claim 1,
wherein a first pressure control valve (PCV1) is arranged between the first electropneumatic solenoid valve device (2C-EVO) and the at least one first brake cylinder (BZ1) and controllable by the electronic service brake control (EBS-ECU), wherein the first pressure control valve (PCV1) is provided and configured to modulate the first service brake pressure (p1).

15. The electropneumatic service brake device according to claim 1,
wherein that the at least one second pressure control valve (PCV2) electrically controllable by the electronic service brake control (EBS-ECU) is arranged between the second electropneumatic solenoid valve device (FAM) and the at least one second brake cylinder (BZ2), and
wherein the second pressure control valve (PCV2) is configured and arranged to modulate the second service brake pressure (p2).

16. The electropneumatic service brake device according to claim 1, further comprising at least one of the following components for generating a trailer service brake pressure for brakes of a trailer:
an electropneumatic trailer control module (TCM) including at least one solenoid valve which is provided with compressed air by the first compressed air storage (13), or by the second compressed air storage (17), or by another compressed air storage, and which is controllable by the electronic service brake control (EBS-ECU) electrically and controllable pneumatically by the first control pressure (Stp1) or by the second control pressure (Stp2); and
a trailer control valve TCV, provided and configured to be pneumatically controlled by the first service brake pressure (p1), or by the second service brake pressure (p2), or by the first control pressure (Stp1), or by the second control pressure (Stp2), and configured to be provided with compressed air by the first compressed air storage (13) or by the second compressed air storage (17) or by another compressed air storage, wherein the second service brake pressure (p2) is modulatable by a third pressure control valve (PCV3) connected upstream of the trailer control valve (TCV).

17. The electropneumatic service brake device according to claim 1, further comprising:
a module that includes at least the electronic service brake control (EBS-ECU) and the first electropneumatic solenoid valve device (2C-EVO).

18. The electropneumatic service brake device according to claim 1,
wherein a first brake circuit includes at least the first compressed air storage (13), the first solenoid valve device (2C-EVO), and the at least one first service brake cylinder (BZ1), and
wherein a second brake circuit includes at least the second compressed air storage (17), the second solenoid valve device (FAM), the at least one second pressure control valve (PCV2), and the at least one second service brake cylinder (BZ2).

19. The electropneumatic service brake device according to claim 17, wherein the first brake circuit is a rear axle brake circuit and the second brake circuit is a front axle brake circuit.

20. A vehicle, comprising: the electropneumatic service brake device according to claim 1.
